(19) United States
(12) Patent Application Publication
(10) Pub. No.: US 2017/0150121 A1
(43) Pub. Date: May 25, 2017

(54) Optical System for Capturing 3D Images

(71) Applicant: Huawei Technologies Co., Ltd., Shenzhen (CN)

(72) Inventors: Angela Liudvigovna Storozheva, Shenzhen (CN); Nikolay Ivanovich Petrov, Shenzhen (CN); Vladislav Gennadievich Nikitin, Shenzhen (CN); Maksim Nikolaevich Khromov, Shenzhen (CN); Yury Mihaylovitch Sokolov, Shenzhen (CN); Alexandre Chtchetinine, Shenzhen (CN)

(21) Appl. No.: 15/427,206

(22) Filed: Feb. 8, 2017

Related U.S. Application Data
(63) Continuation of application No. PCT/RU2014/000736, filed on Sep. 30, 2014.

(51) Int. Cl. H04N 13/02; H04N 13/00; H04N 7/14

(52) U.S. Cl. CPC H04N 13/0228; H04N 7/147; H04N 13/0018; H04N 2213/001; H04N 2013/0088

(57) ABSTRACT

An optical system for capturing 3D images includes: a plurality of optical channels, each optical channel comprising a main lens; a lens array and a receive matrix, the receive matrix being configured to create an elemental image set based on light passing through the main lens and the lens array, wherein a filling degree of the receive matrix is based on an intensity of the light passing through the main lens and the lens array; and an image processor configured to combine the elementary image sets of the plurality of optical channels based on the filling degrees of their receive matrices to produce a combined elementary image set.

### CROSS-REFERENCE TO RELATED APPLICATIONS

This application is a continuation application of international patent application number PCT/RU2014/000736 filed on Sep. 30, 2014, which is incorporated by reference.

### TECHNICAL FIELD

The present disclosure relates to an optical system for capturing 3D images and a method for capturing 3D images, in particular for capturing 3D objects in real-time for video-conference and 3D image display by using integral imaging technology.

### BACKGROUND

Capture of 3D image is presently solved in several ways. In a first realization, the capturing of 3D objects is performed by the use of several cameras at the same time, e.g. using stereoscopy or multi-view. For such a realization, a great number of cameras is required. The number of cameras corresponding to the number of point views determines the number of views of the object and the distance between the cameras determines the motion parallax. In case of stereo-capturing, i.e. using two cameras, there is not enough information for the reproduction of full value 3D image. When stereo-capturing is used the additional views are computed at the stage of the image processing. This operation takes up considerable time for video-conference on this point in time, the additional views are not fully restored and the more motion parallax the more percent of the image cannot be recovered. In a second realization, the capturing of 3D objects is performed by the use of integral imaging technology. In such a realization, a large dimension of the 3D camera is required. In a third realization, the capturing of 3D objects is performed based on the TOF method using a MOEMS-based high-speed light modulator that is highly complex and expensive.

To ensure a comfortable viewing angle of a 3D image for video-conference and accordingly for its capturing, it is necessary to have different views, also called viewpoints or perspectives of the object. In the case of a person or a person's face, taken from different points of a viewpoint, for example, that are separated by a distance equal to the average distance between human eyes that is approximately 65 mm in the case of stereo-capturing a lot of viewpoints are required. Similarly, many viewpoints are required for the scenario of the turning of a person's head during a conversation. The diameter of the main lens of a camera is approximately 200 mm. The additional viewpoints, i.e. motion parallax give the necessary perception set of the 3D-scenes perspectives and have the property of “looking around” an object. The higher the motion parallax or the viewing angle of a 3D object the higher is the distance between the marginal viewpoints. In the case of video-conference application the size of the receiving optical systems will have a large dimension compared to the average size of the human head.

### SUMMARY

It is the object of the disclosure to provide a simple technique for capturing of 3D objects.

This object is achieved by the features of the independent claims. Further implementation forms are apparent from the dependent claims, the description and the figures.

In this disclosure a simple solution for multi-optical channel 3D capturing of an object is presented. The technique for producing the capture of 3D images may include: capturing 3D images by using two or more opto-electronic channels and subsequent image processing of the captured data to obtain the combined 3D scene information received from all opto-electronic channels. Each channel may consist of a main lens, a micro-lens array and a receiving matrix. The dark planes may be placed laterally or between two different optical channels to improve the scheme performance by eliminating ambient light stray effects as described below. Each channel may operate as a system of capturing 3D images based on Integral Image technology. The total area of the objects may be composed of data captured separately by each channel and of data received from the adjacent channels with their subsequent combination. The drawback of lack of information is compensated by using integral imaging technology, i.e. a 3D camera. The drawback of the large size system is solved by the use of a reduced number of small 3D cameras. The drawback of the lack of information and of the large size and large number of cameras, equal to the number of perspectives, is solved by using 3D cameras and a simple image processing. The advantage of the presented technique lies in greater numbers of real perspectives of 3D objects, a small number of cameras, smaller dimensions and a simple image processing.

The basic scenario as described in the following comprises an optical system consisting of a main lens, a cylindrical micro-lens array and a receive matrix. The light transmitted through such a system creates an Elemental Image Set at the receive matrix. Every lens of the micro-lens array may receive light at the full angle 2ω. The main lens is designed to ensure the full angle of 2ω by its aperture. The size of the capture 3D-scene is therefore limited to 2ω and the aperture of main lens. The larger the aperture and the 2ω angle of the main lens, the greater is the number of viewpoints but also the higher is the number of dimensions of the optical system. Aspects of the present disclosure provide a technique for increasing the number of viewpoints without increasing the dimensions of the main lens.

In order to describe the disclosure in detail, the following terms, abbreviations and notations will be used:

ASIC: application-specific integrated circuit

DSP: digital signal processor

EIS: elementary image set

mm: millimeter(s)

MOEMS: micro-opto-electro-mechanical system

TOF: time of flight 3D: three-dimensional.

According to a first aspect, the disclosure relates to an optical system for capturing 3D images, the optical system comprising: a plurality of optical channels, each optical channel comprising a main lens; a lens array and a receive matrix, the receive matrix being configured to create an EIS based on light passing through the main lens and the lens array, wherein a filling degree of the receive matrix is based on an intensity of the light passing through the main lens and the lens array; and an image processor configured to combine the EISs of the plurality of optical channels based on the filling degrees of their receive matrices to produce a combined EIS.

Combining the EISs of the plurality of optical channels based on the filling degrees of their receive matrices allows to increase the full view angle of the 3D capturing scene and also the size of the scene without increasing the size of the optical system. The 3D capturing scene by two channels may be four times bigger than the scene of one channel with the same aperture of the main lens. Therefore, the optical system realizes a simple technique for capturing of 3D objects.

In a first possible implementation form of the optical system according to the first aspect, each lens array of the plurality of optical channels comprises a plurality of micro-lenses, and a filling degree of a particular receive matrix of a particular optical channel is based on an accumulated intensity of light passing through the micro-lenses of the lens array of the particular optical channel. Using a lens array comprising a plurality of micro-lenses allows decreasing the size of the lens array. The optical system can be implemented in a compact and space-efficient manner.

In a second possible implementation form of the optical system according to the first implementation form of the first aspect, a first portion of the particular receive matrix is fully filled with useful information and a second portion of the particular receive matrix is only partially filled with useful information. When a first portion of the receive matrix is fully filled with useful information and the second portion is only partially filled with useful information the efficiency of the optical system may be improved by combining second portions of different receive matrices such that resulting portions are fully or nearly fully filled with useful information. This allows reducing the size of the optical system without losing information or to increase the amount of information at the same size of the optical system.

In a third possible implementation form of the optical system according to the first or the second implementation form of the first aspect, the filling degree of the particular receive matrix is based on aperture angles of the micro-lenses of the lens array of the particular optical channel. It is advantageous to increase the aperture angles of the micro-lenses in order to have a higher filling degree of the receive matrix which means to capture more light, i.e. to gather more information.

In a fourth possible implementation form of the optical system according to the third implementation form of the first aspect, the aperture angles are based on an aperture of the main lens. As the light first passes the main lens and then the micro-lenses it is advantageous to increase the aperture of the main lens in order to capture more light.

In a fifth possible implementation form of the optical system according to the third or the fourth implementation form of the first aspect, the aperture angles are increasing from a border area to a central area of the lens array of the particular optical channel. This characteristic can be advantageously used to combine a border area of a lens array with a border area of another lens array to concentrate the useful information.

In a sixth possible implementation form of the optical system according to any one of the third to the fifth implementation forms of the first aspect, an aperture angle of a particular micro-lens of the lens array of the particular optical channel is based on a position of the particular micro-lens within the lens array of the particular optical channel. The position can advantageously indicate a filling degree of the receive matrix of the particular optical channel. Different receive matrices may be advantageously combined or overlapped based on the position information.

In a seventh possible implementation form of the optical system according to the first aspect as such or according to any of the preceding implementation forms of the first aspect, the optical system comprises a plurality of dark planes placed laterally and/or between the optical channels, wherein the dark planes are configured to eliminate ambient light stray effects. When using dark planes ambient light stray effects can be eliminated thereby providing an improved contrast of the captured image.

In an eighth possible implementation form of the optical system according to the first aspect as such or according to any of the preceding implementation forms of the first aspect the image processor is configured to combine the plurality of EISs based on combining columns of their receive matrices. When columns of the receive matrices are combined the combining scheme is very easy to perform.

In an ninth possible implementation form of the optical system according to the first aspect as such or according to any of the preceding implementation forms of the first aspect the image processor is configured to combine a first elemental image set of a first optical channel of the plurality of optical channels with a second elemental image set of a second optical channel of the plurality of optical channels based on a permutation of columns of a first receive matrix associated with the first elemental image set and a second receive matrix associated with the second elemental image set to provide the combined elemental image set. A permutation of columns of the first receive matrix with columns of the second receive matrix can be efficiently implemented on a common processor. Similarly, the retransformation from the combined elemental image set to the first and second elemental image sets can be easily performed.

In a tenth possible implementation form of the optical system according to the ninth implementation form of the first aspect a size of the combined EIS is smaller than added sizes of the first and the second EIS. When the combined EIS is smaller than added sizes of the first and the second EIS the full view angle of the 3D capturing scene and also the size of the scene can be increased without increasing the size of the optical system.

In an eleventh possible implementation form of the optical system according to the ninth or the tenth implementation form of the first aspect the image processor is configured to only combine columns of the first and second receive matrices which are carrying useful information. When only columns carrying useful information are combined, the full amount of information can be reduced to the useful part thereby allowing a reduction of the size of the optical system. Analogously, more information can be gathered without increasing the size of the optical system.

In a twelfth possible implementation form of the optical system according to the eleventh implementation form of the first aspect a number of columns of the first receive matrix carrying useful information is based on optical parameters of the first optical channel; and a number of columns of the second receive matrix carrying useful information is based on optical parameters of the second optical channel. This provides the advantage that the amount of useful information can be increased by optimizing the optical parameters of the first and second optical channel.

In a thirteenth possible implementation form of the optical system according any of the ninth to the twelfth implementation forms of the first aspect the image processor is configured to merge columns of the first receive matrix not carrying useful information with columns of the second receive matrix carrying useful information such that a number of columns of a combined receive matrix associated with the combined EIS is smaller than a sum of columns of the first and second receive matrices.

When the merging is such that that a number of columns of the combined receive matrix is smaller than a sum of columns of the first and second receive matrices the full view angle of the 3D capturing scene and also the size of the scene can be increased without increasing the size of the optical system.

According to a second aspect, the disclosure relates to a method for capturing 3D images, the method comprising: providing a plurality of optical channels, each optical channel comprising a main lens; a lens array and a receive matrix; for each optical channel using the receive matrix to create an elemental image set based on light passing through the main lens and the lens array of the optical channel, wherein a filling degree of the receive matrix is based on an intensity of the light passing through the main lens and the lens array; and combining the EISs of the plurality of optical channels based on the filling degrees of their receive matrices to produce a combined EIS.

Combining the EISs of the plurality of optical channels based on the filling degrees of their receive matrices allows to increase the full view angle of the 3D capturing scene and also the size of the scene without increasing the size of the optical system. The optical system hence realizes a simple technique for capturing of 3D objects.

According to a third aspect, the disclosure relates to a computer program product comprising a readable storage medium storing program code thereon for use by a computer executing the method according to the second aspect.

The computer program can be flexibly designed such that an update of the requirements is easy to achieve. The computer program product may run on a lot of different processors.

Aspects of the disclosure provide a technique to produce the capture of 3D images. The technique may include: capturing 3D image using two or more opto-electronic channels and subsequent image processing of the captured data to obtain the combined 3D scene information received from all opto-electronic channels. Each channel may consist of a main lens, a micro-lens array and a receiving matrix. Dark planes may be placed laterally or between two different optical channels to improve the scheme performance by eliminating ambient light stray effects. Each channel may operate as a system of capturing 3D images based on Integral Image technology. The total area of the objects may be composed of data captured separately by each channel and of the data received from the adjacent channels, with their subsequent combination.

Aspects of the disclosure provide a multi-channel capturing system consisting of a main lens, a micro-lens array and a receiving matrix together with digital processing of data captured separately by each channel and of the data received from the adjacent channels, with their subsequent combination.

### BRIEF DESCRIPTION OF THE DRAWINGS

Further embodiments of the disclosure will be described with respect to the following figures, in which:

FIG. 1 shows a schematic diagram illustrating an optical system 100 for capturing 3D images according to an implementation form;

FIG. 2 shows a schematic diagram illustrating an optical system 200 for capturing 3D images according to an implementation form;

FIG. 3 shows a schematic diagram illustrating an image processor 300 for capturing 3D images according to an implementation form;

FIG. 4 shows a schematic diagram illustrating an image processing technique 400 for capturing 3D images according to an implementation form; and

FIG. 5 shows a schematic diagram illustrating a method 500 for capturing 3D images according to an implementation form;

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

The devices and methods described herein may be based on capturing 3D images. It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

The methods and devices described herein may be implemented in 3D cameras. The described devices and systems may include software units and hardware units. The described devices and systems may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

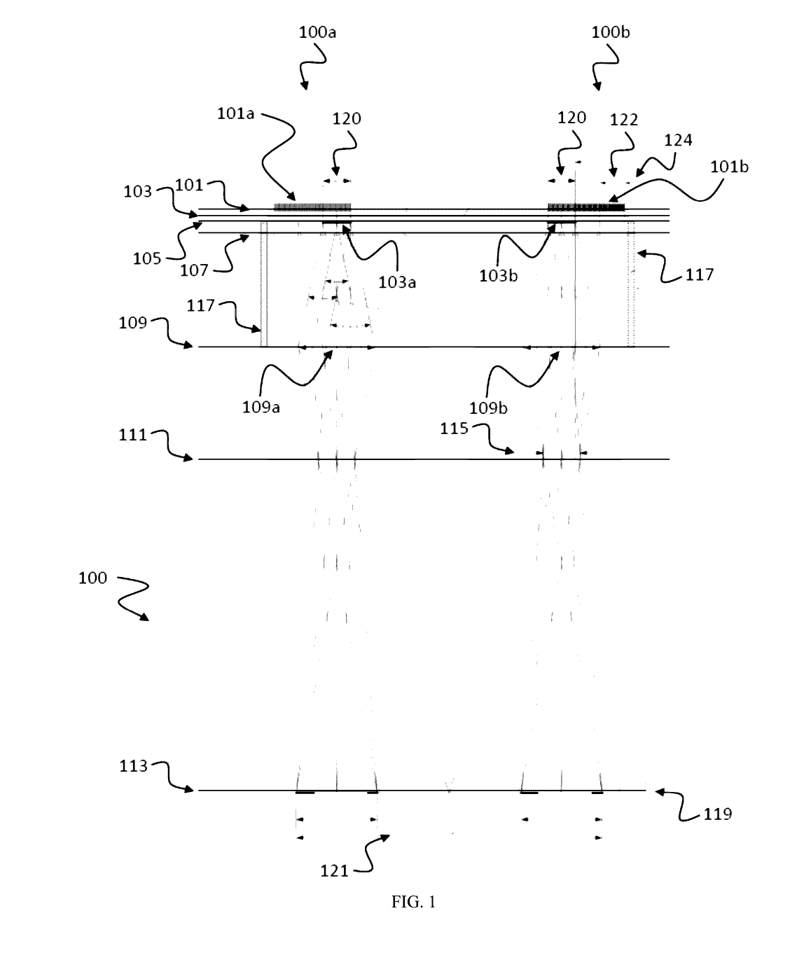

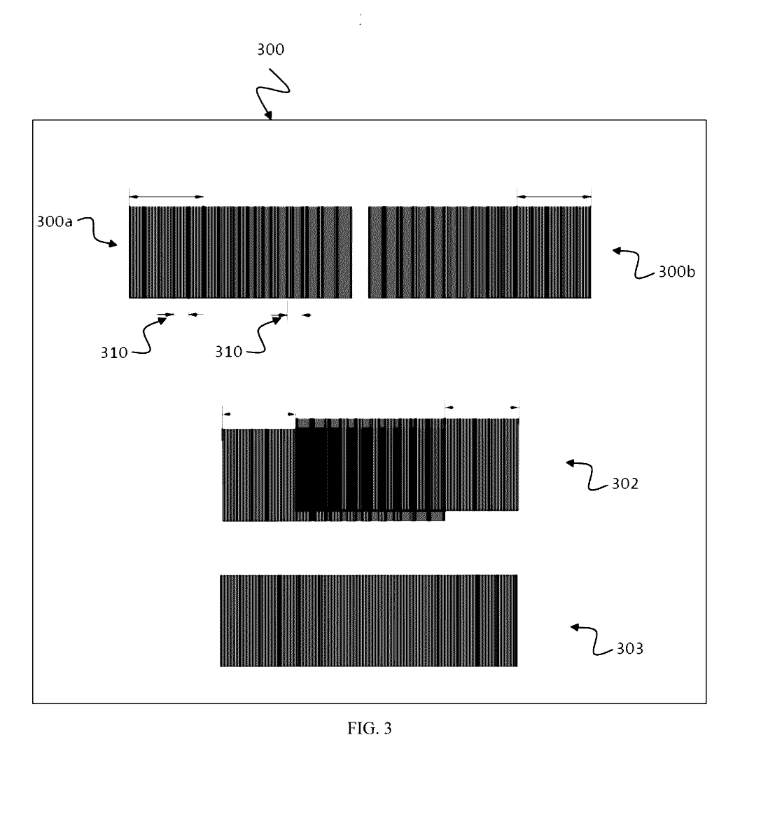

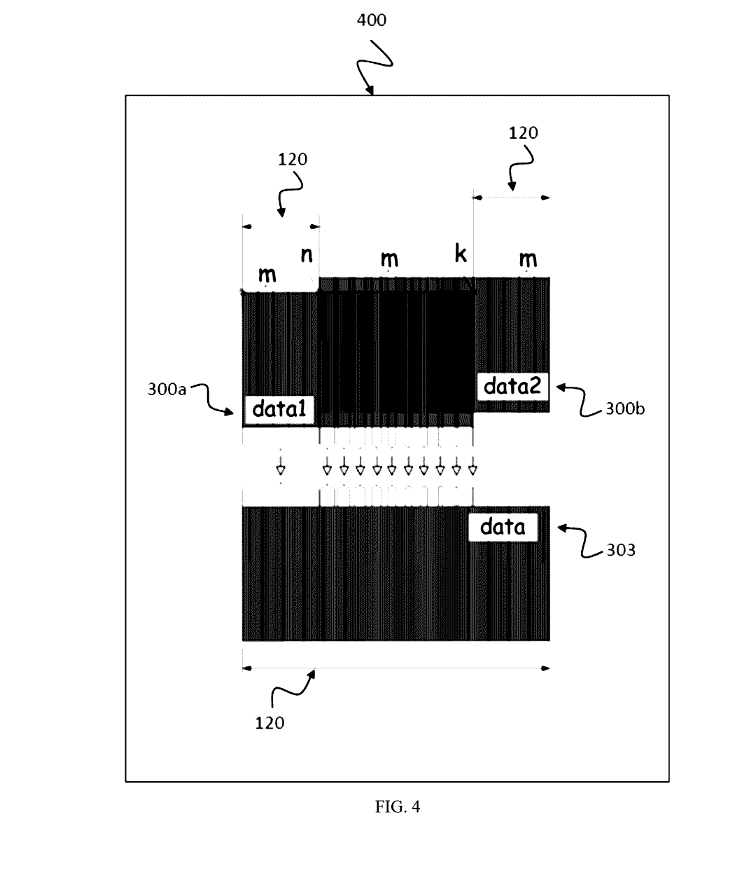

FIG. 1 shows a schematic diagram illustrating an optical system 100 for capturing 3D images according to an implementation form. The optical system 100 includes a plurality of optical channels 100a, 100b (In FIG. 1 only two such optical channels are illustrated to simplify the drawing). Each optical channel 100a, 100b includes a main lens 109a, 109b, a lens array 103a, 103b and a receive matrix 101a, 101b. The receive matrix 101a, 101b creates an elemental image set 300a, 300b as illustrated and described below with respect to FIGS. 3 and 4 based on light passing through the main lens 109a, 109b and the lens array 103a, 103b. A filling degree of the receive matrix 101a, 101b is based on an intensity of the light passing through the main lens 109a, 109b and the lens array 103a, 103b. The optical system 100 further includes an image processor 300 to combine the EISs 300a, 300b of the plurality of optical channels 100a, 100b based on the filling degrees of their receive matrices 101a, 101b to produce a combined EIS 303 as illustrated and described below with respect to FIGS. 3 and 4.

Each lens array 103a, 103b may include a plurality of micro-lenses and a filling degree of a particular receive matrix 101a of a particular optical channel 100a may be based on an accumulated intensity of light passing through the micro-lenses of the lens array 103a of the particular optical channel 100a. A first portion 120 of the particular receive matrix 101a may be fully filled with useful information and a second portion 122, 124 of the particular receive matrix 101a may be only partially filled with useful information. In FIG. 1 the first portion 120 corresponds to the 100% filling region of the EIS and the second portions 122 and 124 correspond to the 50% filling region 122 and the 0% filling region 124 of the EIS. The elemental image set plane is denoted by reference sign 101. The micro-lens array plane is denoted by reference sign 103. The image surface is denoted by reference sign 105. The first focal plane of the main lens is denoted by reference sign 107. The main lens plane is denoted by reference sign 109. The second focal plane of the main lens is denoted by reference sign 111. The reference surface is denoted by reference sign 113. The object space is denoted by reference sign 119. The height H of the object is denoted by reference sign 121. The aperture of the micro-lenses is denoted by reference sign. The aperture of the main lens is denoted by reference sign 115. The length of the first portion 120 corresponding to the 100% filling region of the EIS is denoted by the reference sign. The length of the region on the reference surface 113 corresponding to the 100% filling region 120 is denoted by the reference sign.

Both optical channels 100a, 100b may be approximately parallel with respect to each other as illustrated in FIG. 1. Therefore, the planes 101, 103, 105, 107, 109, 111, 113 of the optical system 100 depicted in FIG. 1 are designed to be parallel planes. Similarly, the dark planes 117 at the borders and in between the optical channels 100a, 100b may be parallel with respect to each other. The dark planes 117 may be placed laterally and/or between the optical channels 100a, 100b. The dark planes 117 may be used to eliminate ambient light stray effects. In FIG. 1 only dark planes at the border of the optical channels 100a, 100b are depicted. However, in another implementation form, a further dark plane 117 may be located between the first 100a and the second 100b optical channel.

The filling degree of the particular receive matrix 101a may be based on the aperture angles of the micro-lenses of the lens array 103a of the particular optical channel 100a. The aperture angles may be based on an aperture 115 of the main lens 109a. The aperture angles may be increasing from a border area to a central area of the lens array 103a of the particular optical channel 100a. In FIG. 1 only the aperture angles of the 100% filling region 120 are illustrated. For the 50% filling region 122 the aperture angles will be smaller than and for the 0% filling region 124 the aperture angles will be still smaller than the aperture angles for the 50% filling region 122. That means an aperture angle of a particular micro-lens of the lens array 103a may be based on a position of the particular micro-lens within the lens array 103a.

Considering one micro-lens of the micro-lens array 103a the 2ω angle ensures the full (i.e. 100%) filling the region of the receive matrix under this micro-lens. As can be seen from FIG. 1, a first part of the light reaching the main lens 109a is transmitted through the main lens 109a under an angle of more or less than 2ω and is subsequently reaching the micro-lens and is fully filling the receive matrix at the 100% filling region 120. A second part of the light reaching the main lens 109a is transmitted through the main lens 109a under an angle of more or less than o and is subsequently reaching the micro-lens and is partially filling the receive matrix at the 50% filling region 122. A third part of the light reaching the main lens 109a is transmitted through the main lens 109a under an angle of more or less than 0 degree and is subsequently reaching the micro-lens and is sparsely filling the receive matrix at the 0% filling region 124. Thus, the receive matrix can form the elemental image set, where a portion of regions of the receive matrix under the micro-lenses may be filled with 100% of light passing through the main lens and other portions of regions of the receive matrix may be filled from 100% down to 0% of the light passing through the main lens 109a.

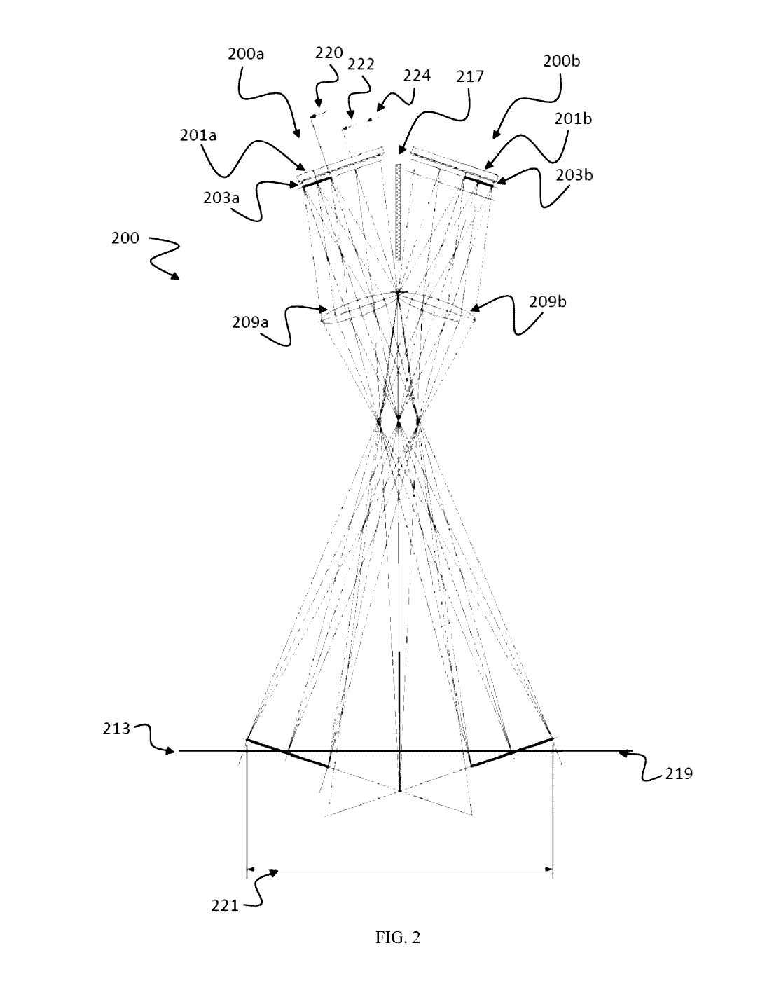

FIG. 2 shows a schematic diagram illustrating an optical system 200 for capturing 3D images according to an implementation form. The optical system 200 includes a plurality of optical channels 200a, 200b (In FIG. 2 only two such optical channels are illustrated to simplify the drawing). Each optical channel 200a, 200b includes a main lens 209a, 209b, a lens array 203a, 203b and a receive matrix 201a, 201b. The receive matrix 201a, 201b creates an elemental image set 300a, 300b as illustrated and described below with respect to FIGS. 3 and 4 based on light passing through the main lens 209a, 209b and the lens array 203a, 203b. A filling degree of the receive matrix 201a, 201b is based on an intensity of the light passing through the main lens 209a, 209b and the lens array 203a, 203b. The optical system 200 further includes an image processor 300 to combine the EISs 300a, 300b of the plurality of optical channels 200a, 200b based on the filling degrees of their receive matrices 201a, 201b to produce a combined EIS 303 as illustrated and described below with respect to FIGS. 3 and 4.

Each lens array 203a, 203b may include a plurality of micro-lenses and a filling degree of a particular receive matrix 201a of a particular optical channel 200a may be based on an accumulated intensity of light passing through the micro-lenses of the lens array 203a of the particular optical channel 200a. A first portion 220 of the particular receive matrix 201a may be fully filled with useful information and a second portion 222, 224 of the particular receive matrix 201a may be only partially filled with useful information. In FIG. 2 the first portion 220 corresponds to the 100% filling region of the EIS and the second portions 222 and 224 correspond to the 50% filling region 222 and the 0% filling region 224 of the EIS.

The reference surface is denoted by reference sign 213. The object space is denoted by reference sign 219. The height H of the object is denoted by reference sign 221. The optical axes of both optical channels 200a, 200b may be non-parallel with respect to each other as illustrated in FIG. 2. A common intersection of the optical axes of both optical channels 200a, 200b may lie between the main lenses 209a, 209b and the reference surface 213. A dark plane 217 may be placed laterally and/or between the optical channels 200a, 200b. The dark plane 117 may be used to eliminate ambient light stray effects. In FIG. 2 only a dark plane between the optical channels 200a, 200b is depicted. However, in another implementation form, further dark planes 117 may be located at the borders of the first 200a and the second 200b optical channel.

It may be necessary to align two or more optical channels 200a, 200b, so that a 3D scene captured by adjacent channels falls at the same time into the regions 220, 222, 224 on receive matrices, wherein the filling is reduced from region 220 via region 222 to region 224 of one optical channel 200a from 100% to 0%, and wherein the filling is accordingly increased from region 224 via region 222 to region 220 of the other optical channel 200b from 0% to 100% when looking from left to right. The dark surface 117 may be used to improve the scheme performance.

FIG. 3 shows a schematic diagram illustrating an image processor 300 for capturing 3D images according to an implementation form. The image processor 300 may be used to combine the EISs 300a, 300b based on combining columns of their receive matrices 101a, 101b, 201a, 201b as described above with respect to FIGS. 1 and 2. The image processor 300 may combine a first elemental image set 300a of the first optical channel 100a with a second elemental image set 300b of the second optical channel 100b based on a permutation of columns of a first receive matrix 101a, 201a associated with the first elemental image set 300a and a second receive matrix 101b, 201b associated with the second elemental image set 300b to provide the combined elemental image set 303. A size of the combined elemental image set 303 may be smaller than added sizes of the first and the second elemental image sets 300a, 300b. The image processor 300 may only combine columns of the first and second receive matrices 101a, 101b, 201a, 201b which are carrying useful information. A number of columns of the first receive matrix 101a, 201a carrying useful information may be based on optical parameters of the first optical channel 100a, 200a. A number of columns of the second receive matrix 101b, 201b carrying useful information may be based on optical parameters of the second optical channel 100b, 200b. The image processor 300 may merge columns of the first receive matrix 101a, 201a not carrying useful information with columns of the second first receive matrix 101b, 201b carrying useful information such that a number of columns of a combined receive matrix associated with the combined elemental image set 303 may be smaller than a sum of columns of the first and second receive matrices 101a, 101b, 201a, 201b. A pitch size of the receive matrices may be denoted by the reference sign 310.

The image processor 300 may put 302 the second EIS 300b on top of the first EIS 300a such that fully filled regions lie on top of sparsely filled regions and vice versa. For example, in the first EIS 300a a fully filled region is located on the left side and a sparsely filled region is located on the right side. In the second EIS 300b a fully filled region is located on the right side and a sparsely filled region is located on the left side. The image processor 300 may generate the combined elemental image set 303 by combining columns of the fully filled region with columns of the sparsely filled regions. In the combined elemental image set 303 these rows of both types are merged such that the combined elemental image set 303 shows a uniform distribution of light.

The EISs 300a, 300b obtained from different receive matrices of corresponding optical channels may be combined according to their filling degrees using the Image processing procedure as illustrated in FIG. 3. This technique allows increasing the full view angle of the 3D capturing scene and also the size of the scene without increasing the size of the optical system. For example, the 3D capturing scene of two channels may be four times bigger than the scene of one channel with the same aperture of the main lens.

FIG. 4 shows a schematic diagram illustrating an image processing technique 400 for capturing 3D images according to an implementation form. The image processing technique 400 may be performed by the image processor 300 as described above with respect to FIG. 3.

The image processing 400 may consist of a combination of the data of channels, i.e. of the EISs 300a, 300b generated by the optical channels 100, 200 as described above with respect to FIGS. 1 and 2. For example, an array of the receive matrix of the optical channels may be called data1 300a and data2 300b, and the total final data array may be called data 303 that may correspond to the combined elemental image set 303 described above with respect to FIGS. 1 to 3. Combining data may be performed by a column permutation. A permutation rule may be according to the following: From the position n to k permute only informative columns, the permutation is carried out at the same position. Position n denotes the first position after the fully filled region 120 in the first receive matrix data1 associated with the first EIS 300a. Position k denotes the last position in the first receive matrix data1 associated with the first EIS 300a. The first receive matrix data1 and the second receive matrix data2 are overlapped such that n further denotes the first position in the second receive matrix data2 associated with the second EIS 300b and that k further denotes the last position before the fully filled region 120 in the second receive matrix data2 associated with the second EIS 300b. The fully filled region 120 is arranged at the left side in the first receive matrix data1 and is arranged at the right side in the in the second receive matrix data2. In particular n is denoted as the column number of pixels of the matrix data1 at which the 100% filling zone 120 ends; k is denoted as the number of the last column of pixels of the matrix data1; and m is denoted as the number of pixel columns of the matrix data1 under one micro-lens. The parameters n, m and k may be determined by the optical parameters of the optical scheme. The permutation of the columns of the matrix may run from the matrix data1 to the matrix data corresponding to the combined EIS 303 as can be seen from FIG. 4. In the result, matrix data is fully filled as the 100% filling zone 120 in matrix data illustrates.

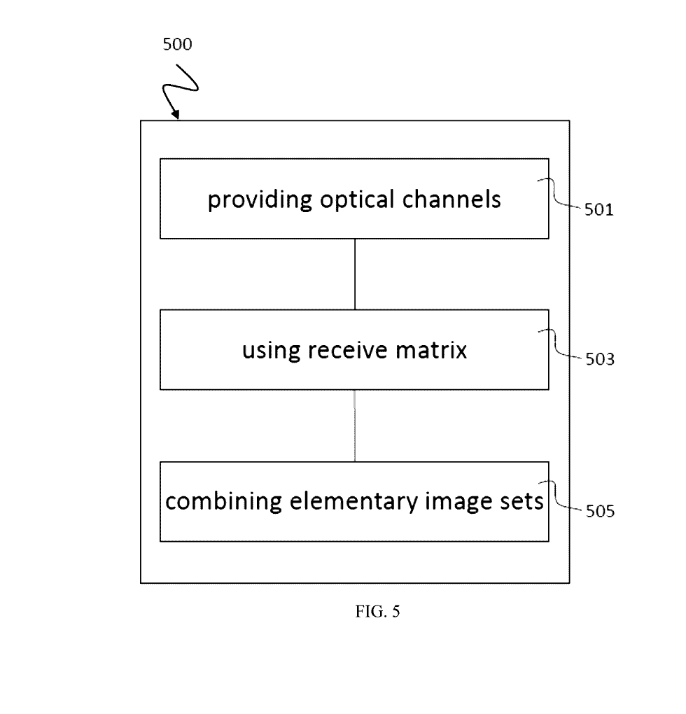

FIG. 5 shows a schematic diagram illustrating a method 500 for capturing 3D images according to an implementation form. The method 500 includes providing 501 a plurality of optical channels, each optical channel comprising a main lens; a lens array and a receive matrix, e.g. as described above with respect to FIGS. 1 to 4. The method 500 further includes for each optical channel using 503 the receive matrix to create an elemental image set based on light passing through the main lens and the lens array of the optical channel, wherein a filling degree of the receive matrix is based on an intensity of the light passing through the main lens and the lens array, e.g. as described above with respect to FIGS. 1 to 4. The method 500 further includes combining 505 the EISs of the plurality of optical channels based on the filling degrees of their receive matrices to produce a combined EIS, e.g. as described above with respect to FIGS. 1 to 4.

The methods, systems and devices described herein may be implemented as software in a DSP, in a micro-controller or in any other side-processor or as hardware circuit within an ASIC of a DSP.

The disclosure can be implemented in digital electronic circuitry, or in computer hardware, firmware, software, or in combinations thereof, e.g. in available hardware of conventional Integral Image processing devices and cameras or in new hardware dedicated for processing the methods described herein.

The present disclosure also supports a computer program product including computer executable code or computer executable instructions that, when executed, causes at least one computer to execute the performing and computing steps described herein, in particular the method 500 as described above with respect to FIG. 5 and the techniques described above with respect to FIGS. 1 to 4. Such a computer program product may include a readable storage medium storing program code thereon for use by a computer. The program code may perform the method 500 as described above with respect to FIG. 5.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the present disclosures has been described with reference to one or more particular embodiments, those skilled in the art recognize that many changes may be made thereto without departing from the scope of the present disclosure. It is therefore to be understood that within the scope of the appended claims and their equivalents, the disclosure may be practiced otherwise than as specifically described herein.

What is claimed is:

1. An optical system for capturing three-dimensional (3D) images, the optical system comprising:
a first optical channel comprising a first main lens, a first lens array, and a first receive matrix configured to create a first elemental image set (EIS) based on a first light passing through the first main lens and the first lens array, wherein a first filling degree of the first receive matrix is based on a first intensity of the first light passing through the first main lens and the first lens array;
a second optical channel comprising a second main lens, a second lens array, and a second receive matrix configured to create a second EIS based on a second light passing through the second main lens and the second lens array, wherein a second filling degree of the second receive matrix is based on a second intensity of the second light passing through the second main lens and the second lens array; and
an image processor coupled to the first receive matrix and the second receive matrix and configured to combine the first EIS and the second EIS based on the first filling degree and the second filling degree to produce a combined EIS.

2. The optical system of claim 1, wherein the first lens array comprises a plurality of micro-lenses, and wherein the first filling degree is based on an accumulated intensity of first light passing through the micro-lenses.

3. The optical system of claim 2, wherein a first portion of the first receive matrix is fully filled with useful information and a second portion of the first receive matrix is partially filled with useful information.

4. The optical system of claim 2, wherein the first filling degree is based on aperture angles of the micro-lenses.

5. The optical system of claim 4, wherein the aperture angles are based on an aperture of the first main lens.

6. The optical system of claim 4, wherein the aperture angles increase from a border area of the first lens array to a central area of the first lens array.

7. The optical system of claim 4, wherein the aperture angles are based on positions of the micro-lenses within the first lens array.

8. The optical system of claim 1, further comprising a dark plane placed laterally or between the first optical channel and the second optical channel and configured to eliminate ambient light stray effects.

9. The optical system of claim 1, wherein the image processor is further configured to further combine the first EIS and the second EIS by combining columns of the first receive matrix and the second receive matrix.

10. The optical system of claim 1, wherein the image processor is further configured to further combine the first EIS with the second EIS based on a permutation of columns of the first receive matrix and the second receive matrix.

11. The optical system of claim 10, wherein a combined size of the combined EIS is smaller than a sum of a first size of the first EIS and a second size of the second EIS.

12. The optical system of claim 10, wherein the image processor is further configured to further combine only the columns carrying useful information.

13. The optical system of claim 12, wherein a number of the columns carrying useful information is based on optical parameters of the first optical channel and the second optical channel.

14. The optical system of claim 10, wherein the image processor is further configured to merge columns of the first receive matrix not carrying useful information with columns of the second first receive matrix carrying useful information such that a number of columns of a combined receive matrix associated with the combined EIS is smaller than a sum of columns of the first and second receive matrices.

15. A method for capturing three-dimensional (3D) images, the method comprising:
providing a first optical channel comprising a first main lens, a first lens array, and a first receive matrix;
providing a second optical channel comprising a second main lens, a second lens array, and a second receive matrix;
using the first receive matrix to create a first elemental image set (EIS) based on a first light passing through the first main lens and the first lens array, wherein a first filling degree of the first receive matrix is based on a first intensity of the first light passing through the first main lens and the first lens array;
using the second receive matrix to create a second EIS based on a second light passing through the second main lens and the second lens array, wherein a second filling degree of the second receive matrix is based on a second intensity of the second light passing through the second main lens and the second lens array; and
combining the first EIS and the second EIS based on the first filling degree and the second filling degree to produce a combined EIS.
